(19) United States
(12) Patent Application Publication
(10) Pub. No.: US 2009/0211453 A1
(43) Pub. Date: Aug. 27, 2009

(54) Filtration Media for the Removal of Basic Molecular Contaminants for Use in a Clean Environment

(76) Inventors: Terry W. Nassivera, Bel Air, MD (US); Fitzgerald A. Sinclair, Smyrna, DE (US); Michael S. Darsillo, Landenberg, PA (US); Ruth G. Heffes, Glen Burnie, MD (US)

Correspondence Address: J M HUBER CORPORATION, 1000 Parkwood Circle, Ste. 1000, PATENT DEPARTMENT, Atlanta, GA, 30339, US

(21) Appl. No.: 12/037,673

(22) Filed: Feb. 26, 2008

(51) Int. Cl. B01D 53/14

(52) U.S. Cl. 96/153

(57) ABSTRACT

Novel acid-impregnated silica materials for use as environmental controls in air handling systems where highly efficient removal of ammonia and volatile amines from gaseous streams is required (e.g. clean rooms) are provided. Such silicas exhibit specific porosity and density measurements to provide a satisfactory support for an acid impregnant incorporated subsequent to initial solid silica particle production, in order to provide effective ammonia bonding sites. The combination of the silica support properties and the acid impregnant permits highly effective ammonia (or volatile amine) gas removal, resulting in excellent noxious gas removal efficiencies and capacities, particularly in comparison with prior media filtration products. Methods of using such acid-impregnated silica filter media and specific filter apparatuses are also encompassed within this invention.

### FIELD OF THE INVENTION

The present invention relates generally to novel acid-impregnated silica materials for use as environmental controls in air handling systems where highly efficient removal of ammonia and volatile amines from gaseous streams is required (e.g. clean rooms). Such silicas exhibit specific porosity and density measurements to provide a satisfactory support for an acid impregnant incorporated subsequent to initial solid silica particle production, in order to provide effective ammonia bonding sites. The combination of the silica support properties and the acid impregnant permits highly effective ammonia (or volatile amine) gas removal, resulting in excellent noxious gas removal efficiencies and capacities, particularly in comparison with prior media filtration products. Methods of using such acid-impregnated silica filter media and specific filter apparatuses are also encompassed within this invention.

### BACKGROUND OF THE INVENTION

There is an ever-increasing need for improved filtration systems for the removal of noxious airborne agents released in the vicinity of an enclosure. The filtration of basic airborne molecular contaminants, such as ammonia and volatile amines, is particularly important in many environments, including museums, archives, and other various agricultural and industrial environments. In these environments, such amine-based gases exhibit highly undesirable corrosivity as well as potentially dangerous toxicity levels. Even relatively low levels of ammonia can cause irreversible damage to documents and equipment, while in agriculture it can cause illness and lower production levels in livestock. Other environments that require ammonia removal properties include semiconductor fabrication sites and clean rooms in which even lower levels of ammonia and other volatile amines can have very detrimental affects on the processes occurring within. For example, as device geometries are reduced further to allow for smaller products and improved performance, ammonia contamination becomes increasingly important since even low levels can impose severe limitations on device resolution. Exposure of wafers in a photo lithography machine to ammonia levels of 8 to 10 ppb can result in severe “T topping” or distortion of the fine details of the image after development.

Typical air filtration systems are generally ineffective against most noxious gases and agents. For example, standard dust filters, such as cardboard framed fiberglass matt filters, exhibit very low propensity for removing micro-sized particles and gases. Commercially available electrostatic fiber filters have higher efficiencies than standard dust filters and can remove pollens and other small solid particulates, but they cannot intercept and remove gases. HEPA (“High-Efficiency Particulate Air”) filters are used for high-efficiency filtration of airborne dispersions of ultra fine solid and liquid particulates such as dust and pollen, radioactive particle contaminants, and aerosols. However, where the threat is a gaseous molecular compound or particle of extremely small size (i.e., <0.001 microns), the conventional commercially-available HEPA filters cannot capture and control these types of airborne agents. As such, a chemical scrubbing apparatus, usually in the form of a loose granular bed and/or an impregnated nonwoven filter, is generally necessary to maintain sufficiently low levels of these airborne contaminants as to not affect the processes occurring within the specified environment.

Filtration of airborne contaminants has been previously implemented in a variety of applications, such as in gas masks, industrial processes, and clean rooms, in which a filter containing a sorbent active toward the removal of a desired contaminant is employed. These commercial filters are typically designed to maintain a removal efficiency for the desired contaminant of at least 99.999%. Although many different media are employed as active adsorbents (zeolites, clays, diatomaceous earth, silicates, and the like), activated carbons are the most common. Such activated carbon filters typically function through physical adsorption where the molecules in the air stream interact with the carbonaceous surface and become entrapped within the pores of the support. Even though this method of removal allows activated carbon to effectively remove a variety of contaminants, special impregnants are also employed to enhance the removal of gases that would otherwise have low affinities with the unimpregnated carbon compound. Such impregnated portions remove the contaminant through chemisorption, where the molecules react with the impregnant and become entrapped within the pores of the support. Such extra impregnated carbons are complex to manufacture, expensive to make, and exhibit suspect reliability.

It has been known that silica-based compositions permit excellent gas filtration results. However, there has been little provided within the pertinent prior art about the breakthrough characteristics (removal efficiency and breakthrough capacity) of such filter medias under conditions that are acceptable for clean room applications. Removal efficiency is a measure of the ability of the filter medium to capture a certain volume of the subject gas under the specified conditions; breakthrough is an indication of the saturation point for the filter medium in terms of its ability to effectively remove a specified percentage of the subject gas under the allotted conditions. Thus, it is highly desirable to find a proper filter medium that exhibits a high removal efficiency (and thus quick capture of large amounts of noxious amine-based gases) and long breakthrough times (and thus, coupled with uptake, the ability to not only effectuate quick capture but also to take extensive lengths of time to reach saturation). The standard ammonia removal filter media used today are either limited to relatively low removal efficiencies with relatively low capacities (relatively quick breakthrough times) but at reasonable costs, or relatively high efficiencies with relatively high capacities but at higher costs. There is a need to develop new filter medium with increased removal efficiencies and breakthrough capacities but at a more economical price point.

In the case of ammonia and other basic nonvolatile amines, acid impregnated sorbents have been used for over 35 years. The closest art concerning the removal of gases such as ammonia utilizing a siliceous compound doped with a mineral or organic acid is taught within U.S. Pat. No. 3,511,596 to Adler et al. This system, which utilized silica gels as the support for the examples, was primarily concerned with providing a filter media for the deodorization of air. It specified the usefulness of these materials in the vicinity of race tracks, dog pounds, veterinary hospitals, other conventional hospitals and clinics, industrial facilities accompanied by the problem of polluted gas, automobile interiors, automobile exhaust systems, business and home air-conditioning systems, as well as special systems such as those associated with furnaces or ovens or in kitchens, to absorb odoriferous compounds. The closest art concerning the removal of gases such as ammonia from air streams in clean room applications, specifically those used in the semiconductor industry, using a compound doped with a mineral or organic acid is taught within PCT Published Application WO96/29100 and U.S. Pat. No. 5,607,647, both to Joffe et al. This system, which primarily used activated carbon as the support (with mention of zeolites and silica gels), was primarily concerned with providing a filter media for the removal of ammonia and other basic amines from clean room environments.

The Adler et al. patent also indicates that the limitation to these types of systems was based on the physical limitations of the support, specifically to its capacity for liquid adsorption (typically based on water adsorption), which limits the type and amount of acid which can be impregnated for use at a given maximum relative humidity. Sulfuric and phosphoric acid will both reach an equilibrium concentration with water at a given relative humidity (e.g. at 70% relative humidity sulfuric acid will absorb moisture until it is at a concentration of 34 weight %, while phosphoric will equilibrate at 50 weight percent). If the water adsorption (pore volume) of the support is insufficient to handle the additional water absorbed, the acid will become external to the pores and will ultimately be free to flow out of the purified bed. To the contrary, an advantage of a system as now proposed is to provide a proper media support, in particular one possessing a sufficiently high liquid adsorption, since the higher the liquid adsorption the higher maximum allowable loading of acid, and thus the higher the total capacity for ammonia at any given relative humidity. The details of the inventive filter media are discussed in greater depth below.

### BRIEF DESCRIPTION OF THE INVENTION

According to one aspect of this invention, provided herein is a filter medium comprising acid-impregnated precipitated silica materials, wherein said materials exhibit a BET surface area of between about 20 and 700 m²/g and a water absorption of between about 50 and 500 cm³ of water per 100 g of silica; and wherein the acid impregnant is selected from the group consisting of mineral acids (such as phosphoric acid, sulfuric acid, hydrochloric acid, nitric acid, sulfamic acid, and the like) and weak organic acids (such as citric acid, oxalic acid, and the like) and is present in an amount of from 1 to 50% by weight of the total amount of the final impregnated media. The porosity of the silica materials may range from microporous to macroporous and the materials themselves are preferably granulated, with the acid predominantly present on the interior surfaces of the subject silica particles.

According to another aspect of the invention, an acid-impregnated precipitated silica filter medium that exhibits a 10% breakthrough measurement for an ammonia gas/air composition [i.e., that exceeds that of an equally sized (e.g. 20×50 US standard mesh) currently utilized impregnated activated carbon support] a) when present as a filter bed of 0.135 cm in height within a flask of a diameter of 4.1 cm, b) when exposed to a constant ammonia gas concentration of 50 ppm at a media velocity of 25 cm/sec at ambient temperature and pressure, and c) when exposed simultaneously to a relative humidity from 10% to 60%; and wherein said filter medium, after 10% breakthrough is reached, does not exhibit any ammonia gas elutibn in excess of said breakthrough concentration. Preferably, the 10% breakthrough time, under the aforementioned conditions, is at least 50 minutes.

One distinct advantage of this invention is the provision of a filter medium that exhibits a high ammonia removal efficiency and capacity when present in a relatively low amount. Among other advantages of this invention is the provision of a filter system for utilization within clean room applications that exhibits a steady and effective uptake of ammonia gas and that removes such noxious gases from an enclosed space at a suitable rate for reduction in concentration below process damaging levels. Yet another advantage is the ability of this invention to irreversibly prevent release of these noxious gases once adsorbed, under normal conditions. Additionally, such precipitated silica materials are cost effective and allow for higher levels of acid impregnation than other absorbent alternatives at a given relative humidity.

Also, said invention encompasses granules that are hardened with a binder system that imparts an increase in granule hardness and does not appreciably compromise the effectiveness of the granulated filter medium to exhibit ammonia removal and capacity. Examples of such a binder system include, without limitation, polysilicic acid binders. Furthermore, the production of such acid-impregnated precipitated silica granules, wherein the acid impregnant is added to the dry silica powder and granulated (via high shear granulation, extrusion, or roller compaction, as examples) is within the scope of the invention as well. Alternatively, the silica based materials may be sprayed or wet impregnated with the acid subsequent to granulation, if desired.

### DETAILED DESCRIPTION OF PREFERRED EMBODIMENTS OF THE INVENTION

The present invention details the use of acid impregnated precipitated silica materials as sorbents for the removal of ammonia and other volatile basic compounds from airstreams. The precipitated amorphous silicas used as supports in the present invention are characterized as having BET surface areas of 20 to 700 m²/g (more preferably, about 200 to about 700 m²/g), linseed oil absorptions of 50 to 500 cm³/100 g (more preferably, about 200 to about 500 cm³/100 g, water absorptions of 50 to 500 cm³/100 g (more preferably, about 200 to about 500 cm³/100 g), pore diameters ranging from 1 to 1000 Å (more preferably, with the majority of the pore volume from 50 to about 500 Å), and average pore diameters ranging from 1 to 500 Å (more preferably, about 100 to about 300 Å). As a result of these physical characteristics and relatively open pore structure, these precipitated silicas are especially well-suited as supports for acidic compounds and subsequently as acid impregnated media for ammonia removal from air streams.

In manufacturing the final granular products of the present invention, a scheme is followed involving, among other things, an initial acid impregnation of the support followed by granulation, using but not limited to, high shear granulation, extrusion, or roller compaction. Prior to or during the granulation process a binder system can be added to aid in the densification and hardening of the final granules. Such binder systems will be discussed in more detail later.

For purposes of this invention, the term “precipitated silica” is intended to encompass materials that are formed from the reaction of a metal silicate (such as sodium silicate) with an acid (such as sulfuric acid) to form an amorphous solid silica material. Typically precipitated silicas are distinguished from silica gels by their higher final pH, such as greater than 6 pH, lower surface areas measured by nitrogen porosimetry typically less than 350 m²/g, and larger median pore diameters above 100 Å. Such materials may be categorized as silicon dioxide, precipitated silica, hydrated silica, colloidal silicon dioxide, amorphous precipitated silica or dental grade silica. The difference between these categories lies strictly within the naming and intended use. In any event, as noted above, the term “precipitated silica” is intended to encompass any and all of these types of materials. It has been found that precipitated silicas typically exhibit a resultant pH of less than about 8.0, contain a percentage of micropores of size less than 20 Å, a median pore diameter of about 100 to 300 Å, and can possess water adsorptions up to about 500 cm³ per 100 g.

While not wishing to be held by theory, it is believed that capture of toxic gases, such as ammonia, is accomplished by two separate (but potentially simultaneous) occurrences within the pores of the acid impregnated precipitated silicas: acid-base reaction with the acid impregnant and physisorption to the surface silanol moieties. Such precipitated silica materials thus exhibit a combination of large pores for quick gas uptake and mass transport and smaller pores connected to such large pores within which acid may be deposited. Basically, it is believed, without being bound to any specific scientific theory, that such smaller pores of suitable size are available to adsorb large quantities of acid and any accompanying water. It is believed that the amount of a gas such as ammonia that is captured and held by the precipitated silica results from a combination of these two means. The ability to tailor the physical properties (i.e. pore size, surface area, water adsorption) in order to best permit acid deposition therein is thus a particularly interesting subject of the invention. The gas, such as ammonia, may enter the pores, and contact the acid species to form stable salts that result in ammonia capture.

Precipitated silica may be produced by reacting an alkali metal silicate and a mineral acid in an aqueous medium. When the quantity of acid reacted with the silicate is such that the final pH of the reaction mixture is alkaline, the resulting product is considered to be precipitated silica. Sulfuric acid is the most commonly used acid, although other mineral acids such as hydrochloric acid, nitric acid, or phosphoric acid may be used. Sodium or potassium silicate may be used, for example, as the alkali metal silicate. Sodium silicate is preferred because it is the least expensive and most readily available. The concentration of the aqueous acidic solution is generally from about 5 to about 70 percent by weight and the aqueous silicate solution commonly has an SiO₂ content of about 6 to about 25 weight percent and a molar ratio of SiO₂ to Na₂O of from about 1:1 to about 3.4:1.

The mineral acid (not to be confused with the acids reacted with the final precipitated silica materials later) is added to the metal silicate solution to form precipitated silica. Alternatively, a portion of the metal silicate is first added to a reactor to serve as the reaction medium and then the remaining metal silicate and the mineral acid are added simultaneously to the medium. Generally, continuous processing can be employed and mineral acid is metered separately into a high speed mixer. The reaction may be carried out at any convenient temperature, for example, from about 15 to about 100° C. and is generally carried out at temperatures between 60 and 90° C.

The silica will generally precipitate directly from the admixture of the reactants and is then washed with water or an aqueous acidic solution to remove residual alkali metal salts which are formed in the reaction. For example, when sulfuric acid and sodium silicate are used as the reactants, sodium sulfate is entrapped in the precipitated silica wet mass. Prior to washing, the mass may be further adjusted with additional mineral acid as is necessary to achieve the desired final pH. The mass may be washed with an aqueous solution of mineral acid such as sulfuric acid, hydrochloric acid, nitric acid, or phosphoric acid or a medium strength acid such as formic acid, acetic acid, or propionic acid.

Generally, the temperature of the wash medium is from about 27° C. to about 93° C. Preferably, the wash water is at a temperature of from about 50° C. to about 93° C. The silica wet mass is washed for a period sufficient to reduce the total salts content to less than about 5 weight percent. The mass may have, for example, a Na₂O content of from about 0.05 to about 3 weight percent and a SO₄ content of from about 0.05 to about 3 weight percent, based on the dry weight of the precipitated silica. The period of time necessary to achieve this salt removal varies with the flow rate of the wash medium and the configuration of the washing apparatus. Generally, the period of time necessary to achieve the desired salt removal is from about 0.05 to about 3 hours. Thus, it is preferred that the precipitated silica mass be washed with water at a temperature of from about 50° C. to about 93° C. for about 0.05 to about 3 hours.

In order to prepare hydrous precipitated silicas suitable for use in the filter media of this invention, the final silica pH upon completion of washing as measured in 5 weight percent aqueous slurry of the silica, may range from about 6 to about 8.

The washed precipitated silica mass generally has a water content, as measured by oven drying at 105° C. for about 16 hours, of from 10 to about 60 weight percent and a particle size ranging from about 1 micron to about 50 millimeters. Alternatively the precipitated silica is then dewatered to a desired water content of from about 20 to about 90 weight percent, preferably from about 50 to about 85 weight percent. Any known dewatering method may be employed to reduce the amount of water therein or conversely increase the solids content thereof. For example, the washed precipitated silica mass may be dewatered in a filter, rotary dryer, spray dryer, tunnel dryer, flash dryer, nozzle dryer, fluid bed dryer, cascade dryer, and the like.

The average particle size referred to throughout this specification is determined in a MICROTRAC® particle size analyzer. When the water content of the precipitated silica is greater than about 20 weight percent, the precipitated silica may be dried in any suitable dryer at a temperature and for a time sufficient to reduce the water content of the precipitated silica to below about 20 weight percent to facilitate handling, processing, and subsequent acid impregnation.

For purposes of this invention, the term “silicon-based gel” is intended to encompass materials that are formed from the reaction of a metal silicate (such as sodium silicate) with an acid (such as sulfuric acid) and permitted to age properly to form a gel material or materials that are available from a natural source (such as from rice hulls) and exhibit pore structures that are similar to such gels as formed by the process above. Such synthetic materials may be categorized as either silicic acid or polysilicic acid types or silica gel types, whereas the natural source materials are typically harvested in a certain form and treated to ultimately form the final gel-like product (such a method is provided within U.S. Pat. No. 6,638,354). The difference between the two synthetic categories lies strictly within the measured resultant pH level of the gel after reaction, formation and aging. If the gel exhibits a pH of below 3.0 after that stage, the gel is considered silicic or polysilicic acid in type. If pH 3.0 or above, then the material is considered a (traditional) silica gel. In any event, as noted above, the term “silicon-based gel” is intended to encompass both of these types of gel materials. It has been found that silicon-based gels exhibiting a resultant pH of less than 3.0 (silicic or polysilicic acid gels) contain a larger percentage of micropores of size less than 20 Å with a median pore size of about 30 Å, while silicon-based gels exhibiting a higher acidic pH, such as pH of 3.0 and above (preferably, though not necessarily, as high as 4) contain a mixture of pore sizes having a median pore size of about 30 Å to about 60 Å.

The precipitated silica particles may be mechanically ground to provide relatively uniform particles sizes suitable for further impregnation with the acid and the subsequent production of sufficiently uniform application thereof of the acid on the interior surfaces of the subject particles for the most effective acid holding and ammonia removal while present within a filter medium. For example, the precipitated silica may be ground with any standard mechanical grinding device, such as a hammer mill, as one non-limiting example. Another option is to subject the selected silica materials to high shear mixing during the acid impregnation procedure. In such alternative manners, the overall production method can effectuate the desired homogeneous impregnation of the acid for the most effective ammonia (or other volatile amine) gas removal upon utilization as a filter medium.

The ultimate particle sizes of the acid-impregnated precipitated silica materials are dependent upon the desired manner of providing the filter medium made there from. Thus, packed media will require larger particle sizes (from 100 microns to 5 millimeters, for example) whereas relatively small particles sizes (from 1 to 100 microns, for example) may be utilized as extrudates within films or fibers or a powdered impregnants. The important issue, however, is not the particle sizes in general, but, again, the degree of and uniformity of acid presence on the surface of the subject silica materials themselves.

The acid-impregnated precipitated silicas of the invention can also further contain as optional ingredients, silicates, clays, talcs, aluminas, carbons, polymers, including but not limited to polysaccharides, gums or other substances used as binder fillers to harden the granules. These are conventional components of filter media, and materials suitable for this purpose need not be enumerated for they are well known to those skilled in the art. However, the binding capabilities of some of these additives can either be disrupted by the acid impregnants and/or can negatively affect the chemical performance of the media by reacting with and consuming said impregnants. Therefore, in another embodiment a polysilicic acid binder is utilized to harden the granules while minimally affecting the chemical performance. Furthermore, such acid impregnated precipitated silica materials of the invention may also be introduced within a polymer composition (through impregnation, or through extrusion) to provide a polymeric film, composite, or other type of polymeric solid for utilization as a filter medium. Additionally, a nonwoven fabric may be impregnated, coated, or otherwise treated with such invention materials, or individual yarns or filaments may be extruded with such materials and formed into a nonwoven, woven, or knit web, all to provide a filter medium base as well. Additionally, the inventive filter media may be layered within a filter canister with other types of filter media present therewith (such as layers of carbon black material), or, alternatively, the filter media may be interspersed together within the same canister. Such films and/or fabrics, as noted above, may include discrete areas of filter medium, or the same type of interspersed materials (carbon black mixed on the surface, or co-extruded, as merely examples, within the same fabric or film) as well.

The filter system utilized for testing of the viability of the medium for clean room applications typically contains a media bed thickness of from about 0.125 cm to about 0.318 cm thickness, preferably about 0.135 cm thickness within a flask of 4.1 cm in diameter. Without limitation, typical filters that may actually include such a filter medium, for example, for industrial and/or personal use, will comprise greater thicknesses (and thus amounts) of such a filter medium, from about 1-15 cm in thickness and approximately 10 cm in diameter, for example for personal canister filter types, up to 100 cm in thickness and 50 cm in diameter, at least, for industrial uses. On the other hand clean room filters, will comprise smaller thicknesses (and thus amounts) of such a filter medium, typically in the form of either pleated or non-pleated non-woven filters. Again, these are only intended to be rough approximations for such end use applications; any thickness, diameter, width, height, etc., of the bed and/or the container may be utilized in actuality, depending on the length of time the filter may be in use and the potential for gaseous contamination the target environment may exhibit. The amount of filter medium that may be introduced within a filter system in any amount, as long as the container is structurally sufficient to hold the filter medium therein and permits proper airflow in order for the filter medium to properly contact the target gases.

It is important to note that although ammonia gas is the test subject for removal by the inventive filter media discussed herein; such media may also be effective in removing other noxious gases from certain environments as well, including other volatile basic compounds (such as volatile amines), as merely examples.

The filter medium can be used in various filtration applications in an industrial setting (such as protecting entire industrial buildings or individual workers, via masks), a military setting (such as filters for vehicles or buildings), and commercial/public settings (office buildings, shopping centers, museums, governmental locations and installations, and the like). Specific examples may include, without limitation, the protection of workers and livestock in agricultural environments, such as within poultry houses, as one example, where vast quantities of ammonia gas can be generated by animal waste, and anywhere where potentially hazardous amounts of ammonia gas is generated. Thus, large-scale filters may be utilized in such locations, or individuals may utilize personal filter apparatuses for such purposes. Other environments where this medium can be used, and that pertain to this specific invention, include semiconductor fabrication sites and clean rooms, in which even lower levels of ammonia and other volatile amines can have very detrimental affects on the processes occurring within. Generally, such inventive filter media may be included in any type of filter system that is necessary and useful for the removal of potential noxious gases in any type of environment.

### PREFERRED EMBODIMENTS OF THE INVENTION

While the invention will be described and disclosed in connection with certain preferred embodiments and practices, it is in no way intended to limit the invention to those specific embodiments, rather it is intended to cover structural equivalents and all alternative embodiments and modifications as may be defined by the scope of the appended claims and equivalence thereto.

### Test Protocols for Support Measurements

The % solids of the adsorbent wet cake were determined by placing a representative 2 g sample on the pan of a CEM 910700 microwave balance and drying the sample to constant weight. The weight difference is used to calculate the % solids content. Pack or tapped density is determined by weighing 100.0 grams of product into a 250-mL plastic graduated cylinder with a flat bottom. The cylinder is closed with a rubber stopper, placed on the tap density machine and run for 15 minutes. The tap density machine is a conventional motor-gear reducer drive operating a cam at 60 rpm. The cam is cut or designed to raise and drop the cylinder a distance of 2.25 in. (5.715 cm) every second. The cylinder is held in position by guide brackets. The volume occupied by the product after tapping was recorded and pack density was calculated and expressed in g/ml.

The conductivity of the filtrate was determined utilizing an Orion Model 140 Conductivity Meter with temperature compensator by immersing the electrode epoxy conductivity cell (014010) in the recovered filtrate or filtrate stream. Measurements are typically made at a temperature of 15-20° C.

Surface area is determined by the BET nitrogen adsorption methods of Brunaur et al., J. Am. Chem. Soc., 60, 309 (1938). Accessible has been obtained using nitrogen adsorption-isotherm measurements. The BJH (Barrett-Joiner-Halender) model average pore diameter was determined based on the branch utilizing an Accelerated Surface Area and Porosimetry System (ASAP 2010) available from Micromeritics Instrument Corporation, Norcross, Ga. Samples were out gassed at 150-200° C. until the vacuum pressure was about 5 μm of Mercury. This is an automated volumetric analyzer at 77° K. Pore volume is obtained at pressure P/P₀=0.99. Average pore diameter is derived from pore volume and surface area assuming cylindrical pores. Pore size distribution (ΔV/ΔD) is calculated using BJH method, which gives the pore volume within a range of pore diameters. A Halsey thickness curve type was used with pore size range of 1.7 to 300.0 nm diameter, with zero fraction of pores open at both ends.

The N₂ adsorption and desorption isotherms were classified according to the 1985 IUPAC classification for general isotherm types including classification of hysteresis to describe the shape and inter connectedness of pores present in the precipitated silicas.

Adsorbent micropore area (S_{micro}) is derived from the Halsey isotherm equation used in producing a t-plot. The t-plot compares a graph of the volume of nitrogen absorbed by the adsorbent as compared with the thickness of the adsorbent layer to an ideal reference. The shape of the t-plot can be used to estimate the micropore surface area. Percent microporosity is then estimated by subtracting the external surface area from the total BET surface area, where S_{micro}=S_{BET}−Sₑₓₜ. Thus % BJH microporosity=S_{micro}/S_{BET}×100.

The water absorption of the supports was determined using a Brabender Absorptometer C. Water was added to the support and the water adsorption was defined as when 100% torque was reached. This value was then corrected for the initial moisture on the support, by taking the initial moisture on 100 g of silica, adding it to the water absorbed by 100 g of silica in the Brabender test, dividing it by the dry weight of 100 g of the silica, and multiplying by 100.

For example:

Corrected H₂O Absorption=((Brabender H₂O+Initial Moisture)/Dry Silica)×100

| Mass of | | Mass of | | Corrected Water |
|---|---|---|---|---|
| Silica | Initial Moisture | Dry | Brabender H₂O | Absorption |
| (g) | (g) | Silica (g) | (g) | (cc/100 g) |
| 100 | 10 | 90 | 100 | 122.2 |

Oil absorption, for linseed, was determined by the “rub out” method. This method is based on a principle of mixing a oil with a silica by rubbing with a spatula on a smooth surface until a stiff putty-like paste is formed. By measuring the quantity of oil required to have a paste mixture which will when spread out, one calculates the oil absorption value for the silica, i.e., the value which represents the volume of oil required per unit weight of silica to saturate the silica absorptive capacity. Calculation of the oil absorption value was done as follows:

Oil absorption=100×(cm³ oil absorbed/wt. of silica in grams).

Ball-pan hardness was determined using a modified Method of the ASTM Ball-Pan Hardness of Activated Carbon (ASTM: D 3802-79).

The 5% pH was measured using a 5% aqueous slurry made by stirring together 10 g of dry media and 190 g for deionized water.

### Ammonia Filtering Measurements

The general protocol utilized for breakthrough measurements involved the use of a flow system with a three way valve leading to either a test cell (including the filter medium) or a bypass line (with no filter medium), both of which are connected to an infrared detector (to monitor the effluent concentration of ammonia) followed by a mass flow controller (to regulate the flow rate and media velocity). The overall system basically permitted mixing of ammonia and air within the same pipeline for transfer to either the adsorbent bed or directly to the IR. A vacuum was utilized at the end of the system to force the ammonia/air mixture through the flow system as well as the non-filtered pipeline with the flow being controlled by a 0-30 SLPM Brooks Instrument 5850E mass flow controller.

To generate air with the appropriate relative humidity, two mass flow controllers controlled the percentage of dry air and wet air (produced by flowing through a heated bubbler humidifier) flowing into a mixing chamber. To generate the challenge concentration of ammonia, one mass flow controller having a 0-200 SCCM range, metered in the appropriate amount of concentrated ammonia gas (˜8%) into the test line that was being drawn through the filter bed from the air mixing chamber and whose flow was controlled by the 0-30 SLPM effluent mass flow controller. Two humidity probes, one located in the challenge air line above the bed and the other measuring the effluent RH coming out of the filter beds, were utilized to determine the RH thereof (modified for different levels).

The test cell was made using a 4.1 cm glass tube with a baffled screen to hold the adsorbent. The adsorbent was introduced into the glass tube using a shaker and smoothed to obtain the best and most uniform packing each time.

The challenge and effluent chemical concentrations were then measured using a infrared analyzer (MIRAN), previously calibrated at a specific wavelength for ammonia.

The adsorbent was prepared for testing by screening all of the particles below 50 mesh (˜297 microns). The largest particles were typically no larger than about 20 mesh (˜850 microns). The dry air flow, the water humidified air flow, and the challenge air flow (19608 SCCM) were all started. The air flow was sent through an empty test cell and the system was allowed to equilibrate at the desired temperature and relative humidity (RH). The valve above the bed was then switched to the bypass line, the test cell was replaced with one containing a 0.135 cm deep sorbent bed, and the valve was switched back to allow air flow through the bed. At the start of the test run the chemical flow was started and kept at a flow rate to achieve the desired challenge chemical concentration of 50 ppm. The effluent concentration from the adsorbent bed (filter media) was measured continuously using the previously calibrated infrared detector. The breakthrough time was defined as the time when the effluent chemical concentration equaled the targeted percent breakthrough of 10% (roughly 5 ppm). For ammonia tests, the challenge concentration was 50 ppm at 25° C. and the desired percent breakthrough was 10% at 25° C. Ammonia breakthrough was then measured for distinct filter medium samples, with a bed depth of 0.135 cm, a relative humidity of 50%, and an challenge flow rate of 19608 SCCM to give a media velocity of approximately 25 cm/sec. A breakthrough time exceeding that of the currently available acid impregnated carbon was targeted.

### BRIEF DESCRIPTION OF THE DRAWINGS

Certain graphical representations accompany the text description of this invention. Nothing therein should be considered as limiting the scope of the invention.

FIGS. 1 and 2 are graphical representations relating to the information provided within TABLE 3, below, in terms of the concentration of ammonia uptake by the subject inventive and comparative filter media materials over time.

FIG. 3 is a graphical representation relating to the information provided within TABLE 4, below, in terms of the concentration of ammonia uptake by the subject inventive medias containing a comparative CATAPAL® binder system.

FIG. 4, is a graphical representation relating to the information provided within TABLE 5, below, in terms of the concentration of ammonia uptake by the subject inventive media containing an inventive polysilicic acid binder system and a comparative filter media material over time.

### Silica Support Production

The actual support materials and/or methods used to produce the silica supports used in the production of the acid impregnated materials for ammonia removal are provided as follows:

### Silica Support A

Silica Support A was commercially available Zeodent 103.

### Silica Support B

Silica Support B was produced in a 30 gallon reactor by starting with 24.0 L of water with an agitation of 80 rpm, to which 362.5 g of sodium sulfate was added and stirred until dissolved. After the salt was dissolved, 31.625 L of a 15% 3.3 mol ratio sodium silicate solution (SG 1.12991) was added and the mixture was heated to 72° C. Once the mixture reached the desired temperature an 11.4% Sulfuric acid solution (SG 1.079) was added at a rate of 1.025 L/min until the solution reached a pH of 9.5. At this point the agitation rate was increased, as a result of the increased viscosity, and the mixture was stirred through the opalescence point and until the pH decreased back to ˜9.5. At this point the stir rate was decreased back to 80 rpm, the temperature was raised to 92° C., and the acid addition continued to pH of 7.5. Once the temperature and pH have reached the target values, a co-addition of 3.3 mol ratio 15% sodium silicate and 11.4% H₂SO₄ was started at a rate of 100.5 mL/min and 100 mL/min respectively for exactly 30 minutes while maintaining the pH between 7.4 and 7.6. After 30 minutes the silicate was stopped and the acid addition continued until the pH reached 5.5 with further digestion for ten minutes, and subsequent readjustment of the pH to 5.5. The resultant wetcake was then filtered and washed to a conductivity of <3000 m/cm² after which it was spray dried.

### Silica Support C

Silica Support B was produced in a 400 gallon reactor by starting with 588 L of fresh water heated to 44° C. To this water silicate and acid were added at a rate of 4.95 L/min and 2.58 L/min, respectively for 60 min. Slight adjustments were made to the acid addition rate to maintain a batch pH of 6.0±0.2. After 60 minutes the acid flow was stopped while the silicate addition continued until a batch pH of 7.5 was reached, then the flow was stopped. The reactor temperature was maintained at 44° C. during simultaneous addition. After the simultaneous addition was complete the mixture was heated to 90.5° C. After the mixture reached the desired temperature acid was added at a rate of 2.71 L/min until a final pH adjust of 5.7-5.9, then stop. The slurry was digested for 10 minutes and the pH was adjusted to 5.7-5.9 and the batch was dropped. The resultant product was then filtered and washed to a 1.00% sulfate target, and adjusted to a dry pH of 6.5-7.5 with further acid addition. Subsequently, the product was then dried to a moisture level of 3-6% moisture.

### Silica Support D

Silica Support D was commercially available SIPERNAT® 50S from Degussa

The physical properties of these precipitated silica supports that were used in the following examples are provided in Table 1.

TABLE 1
Silica Supports Characteristics

| | | | Water | |
|---|---|---|---|---|
| | BET Surface | Oil Absorption | Absorption | Average Pore |
| Support | Area (m²/g) | (cm³/g) | (cm³/g) | Diameter (Å) |
| A | 30 | 60 | 73 | 275 |
| B | 258 | 113 | 218 | 148 |
| C | 262 | 234 | 320 | 212 |
| D | 480 | 272 | 318 | 127 |

### Silica Filter Media Production

The preferred embodiments including acid-impregnated precipitated silica materials for ammonia removal are provided as follows:

### INVENTIVE EXAMPLE 1

An acid-impregnated media was made using the low structure precipitated silica support A. To create a homogeneously impregnated 30% H₂SO₄ by total weight of the dry media, 66.6 g of conc. H₂SO₄ (96.5%) was added to 150 g of the dry silica under high shear. To form granules and increase product density, the homogeneous acid impregnated silica powder was then wet granulated under high shear, by adding additional water until granules were formed (granulation could also be achieved using other methods, e.g., roller compaction or extrusion). The wet granules were then dried at 150° C. until a moisture of <10% was achieved. The granules formed were then sized by sieving to recover granules between 850 μm and 297 μm (20×50 US standard mesh).

### INVENTIVE EXAMPLE 2

A second acid-impregnated media was made using the low structure precipitated silica support A. To create a homogeneously impregnated 40% H₂SO₄ by total weight of the dry media, 103.6 g of conc. H₂SO₄ (96.5%) was added to 150 g of the dry silica under high shear. To form granules and increase product density, the homogeneous acid impregnated silica powder was then wet granulated under high shear, by adding additional water until granules were formed (granulation could also be achieved using other methods, e.g., roller compaction or extrusion). The wet granules were then dried at 150° C. until a moisture of <10% was achieved. The granules formed were then sized by sieving to recover granules between 850 μm and 297 μm (20×50 US standard mesh).

### INVENTIVE EXAMPLE 3

An acid-impregnated media was made using the relatively high structure precipitated silica support B. To create a homogeneously impregnated 30% H₂SO₄ by total weight of the dry media, 66.6 g of conc. H₂SO₄ (96.5%) was added to 60 g of H₂O and this solution was added to 150 g of the dry silica under high shear. To form granules and increase product density, the homogeneous acid impregnated silica powder was then wet granulated under high shear, by adding additional water until granules were formed (granulation could also be achieved using other methods, e.g., roller compaction or extrusion). The wet granules were then dried at 150° C. until a moisture of <10% was achieved. The granules formed were then sized by sieving to recover granules between 850 μm and 297 μm (20×50 US standard mesh).

### INVENTIVE EXAMPLE 4

A second acid-impregnated media was made using the relatively high structure precipitated silica support B. To create a homogeneously impregnated 40% H₂SO₄ by total weight of the dry media, 103.6 g of conc. H₂SO₄ (96.5%) was added to 60 g of H₂O and this solution was added to 150 g of the dry silica under high shear. To form granules and increase product density, the homogeneous acid impregnated silica powder was then wet granulated under high shear, by adding additional water until granules were formed (granulation could also be achieved using other methods, e.g., roller compaction or extrusion). The wet granules were then dried at 150° C. until a moisture of <10% was achieved. The granules formed were then sized by sieving to recover granules between 850 μm and 297 μm (20×50 US standard mesh).

### INVENTIVE EXAMPLE 5

An acid-impregnated media was made using the high structure precipitated silica support C. To create a homogeneously impregnated 30% H₂SO₄ by total weight of the dry media, 44.4 g of conc. H₂SO₄ (96.5%) was added to 100 g of H₂O and this solution was added to 100 g of the dry silica under high shear. To form granules and increase product density, the homogeneous acid impregnated silica powder was then wet granulated under high shear, by adding additional water until granules were formed (granulation could also be achieved using other methods, e.g., roller compaction or extrusion). The wet granules were then dried at 150° C. until a moisture of <10% was achieved. The granules formed were then sized by sieving to recover granules between 850 μm and 297 μm (20×50 US standard mesh).

### INVENTIVE EXAMPLE 6

A second acid-impregnated media was made using the high structure precipitated silica support C. To create a homogeneously impregnated 40% H₂SO₄ by total weight of the dry media, 69.1 g of conc. H₂SO₄ (96.5%) was added to 100 g of H₂O and this solution was added to 100 g of the dry silica under high shear. To form granules and increase product density, the homogeneous acid impregnated silica powder was then wet granulated under high shear, by adding additional water until granules were formed (granulation could also be achieved using other methods, e.g., roller compaction or extrusion). The wet granules were then dried at 150° C. until a moisture of <10% was achieved. The granules formed were then sized by sieving to recover granules between 850 μm and 297 μm (20×50 US standard mesh).

Silica Filter Media with Binder Production

A preferred embodiment and comparative examples including acid-impregnated precipitated silica materials with binders for ammonia removal are provided as follows:

### INVENTIVE EXAMPLE 6

An acid-impregnated medium was made using the high structure precipitated silica support C. To create a homogeneous loading of the acid, 40% H₂SO₄ by total weight of the dry silica, 690.8 g of conc. H₂SO₄ (96.5%) was added directly to 1000 g of the dry silica under high shear using an Eirich mixer. Previously, an aqueous polysilicic acid binder was produced by adding a 24.7% 3.3 mol ratio sodium silicate solution, under high shear and at a rate of 40 mL/min, to 1000 g of an 11% H₂SO₄ solution until a pH of 2.5 was reached. At this point a clear pseudo stable polysilicic acid solution with a relatively low viscosity is produced (this solution did not gel after sitting for more than 7 hours at room temp). To form granules and increase product density, the homogeneous acid impregnated powder was then wet granulated under high shear using an eirich mixer, by adding the aqueous polysilicic acid binder until granules were formed (granulation could also be achieved using other methods, e.g., roller compaction or extrusion). The wet granules were then dried at 150° C. until a moisture of <10% was achieved. This drying step also increases the polymerization rate of the polysilicic acid binder causing it to harden. The granules formed were then sized by sieving to recover granules between 850 μm and 297 μm (20×50 US standard mesh).

### COMPARATIVE EXAMPLE 1

A filter medium was made using the high structure precipitated silica support D. To create a homogeneous loading of the binder at 20%, based on the total dry weight of the silica and binder, 80 g of dry silica and 20 g of ATTAGEL® 350, from Engelhard, were blended together under high shear using a cuisinart mixer. To form granules and increase product density, the homogeneous Attagel 350 and silica powder was then wet granulated under high shear using a cuisinart mixer by adding additional water until granules were formed (granulation could also be achieved using other methods, e.g., roller compaction or extrusion). The wet granules were then dried at 150° C. until a moisture of <10% was achieved. The dry granules were then sized by sieving to recover granules between 850 μm and 297 μm (20×50 US standard mesh).

### COMPARATIVE EXAMPLE 2

A second acid-impregnated medium was made using the high structure precipitated silica support D. To create a homogeneous loading of the binder at 20%, based on the total dry weight of the silica and binder, 110 g of dry silica and 28 g of Attagel 350 were blended together under high shear using a cuisinart mixer. To create a homogeneously impregnated ˜40% H₂SO₄ by total weight of the dry media, 92 g of conc. H₂SO₄ (96.5%) was added to 92 g of H₂O, and this solution was added to the dry silica/Attagel 350 mixture under high shear. To form granules and increase product density, the homogeneous Attagel 350, silica powder, and acid powder was then wet granulated under high shear using a cuisinart mixer by adding additional water until granules were formed (granulation could also be achieved using other methods, e.g., roller compaction or extrusion). Prior to final granulation 5 g of CATAPAL® pseudo boehmite from Sasol was added. The wet granules were then dried at 150° C. until a moisture of <10% was achieved. The dry granules were then sized by sieving to recover granules between 850 μm and 297 μm (20×50 US standard mesh).

### COMPARATIVE EXAMPLE 3

A further acid-impregnated medium was made using the high structure precipitated silica support C. To create a homogeneous loading of the binder at 10%, based on the total dry weight of the silica and binder, 90 g of dry silica and 10 g of Catapal were blended together under high shear using a cuisinart mill. To create a homogeneously impregnated 40% H₂SO₄ by total weight of the dry media, 69.1 g of conc. H₂SO₄ (96.5%) was added to 100 g of H₂O and this solution was added to 100 g of the dry silica/Catapal mixture under high shear. To form granules and increase product density, the homogeneous acid impregnated powder was then wet granulated under high shear, by adding additional water until granules were formed (granulation could also be achieved using other methods, e.g., roller compaction or extrusion). The wet granules were then dried at 150° C. until a moisture of <10% was achieved. The granules formed were then sized by sieving to recover granules between 850 μm and 297 μm (20×50 US standard mesh).

### COMPARATIVE EXAMPLE 4

Another acid-impregnated medium was made using the high structure precipitated silica support C. To create a homogeneous loading of the binder at 20%, based on the total dry weight of the silica and binder, 80 g of dry silica and 20 g of Catapal (pseudo boehmite from Sasol) were blended together under high shear using a Cuisinart mill. To create a homogeneously impregnated 40% H₂SO₄ by total weight of the dry media, 69.1 g of conc. H₂SO₄ (96.5%) was added to 90 g of H₂O and this solution was added to 100 g of the dry silica/Catapal mixture under high shear. To form granules and increase product density, the homogeneous acid impregnated powder was then wet granulated under high shear, by adding additional water until granules were formed (granulation could also be achieved using other methods, e.g., roller compaction or extrusion). The wet granules were then dried at 150° C. until a moisture of <10% was achieved. The granules formed were then sized by sieving to recover granules between 850 μm and 297 μm (20×50 US standard mesh).

### COMPARATIVE EXAMPLE 5

An additional acid-impregnated medium was made using the high structure precipitated silica support C. To create a homogeneous loading of the binder at 30%, based on the total dry weight of the silica and binder, 70 g of dry silica and 30 g of Catapal (pseudo boehmite from Sasol) were blended together under high shear using a cuisinart mill. To create a homogeneously impregnated 40% H₂SO₄ by total weight of the dry media, 69.1 g of conc. H₂SO₄ (96.5%) was added to 80 g of H₂O and this solution was added to 100 g of the dry silica/Catapal mixture under high shear. To form granules and increase product density, the homogeneous acid impregnated powder was then wet granulated under high shear, by adding additional water until granules were formed (granulation could also be achieved using other methods, e.g., roller compaction or extrusion). The wet granules were then dried at 150° C. until a moisture of <10% was achieved. The granules formed were then sized by sieving to recover granules between 850 μm and 297 μm (20×50 US standard mesh).

Certain examples (hardened or simply acid-impregnated as well as an acid-impregnated carbon control) were measured for pH level and/or hardness. The results are tabulated in the following:

TABLE 2
Compositional Information for Inventive Precipitated Silica Materials

| | | Modified Ball-Pan |
|---|---|---|
| Inventive Example | 5% pH | Hardness |
| Acid-Impregnated | 1.81 | — |
| Carbon | | |
| 6 | 1.10 | 41 |
| 7 | — | 67 |
| 8 | — | 48 |
| 9 | 1.22 | 43 |
| 10 | 1.37 | 71 |
| 11 | 2.03 | 75 |
| 12 | — | 60 |

### Acid-Impregnated Silica Filter Media (No Binder Added)

i. 30% Loading

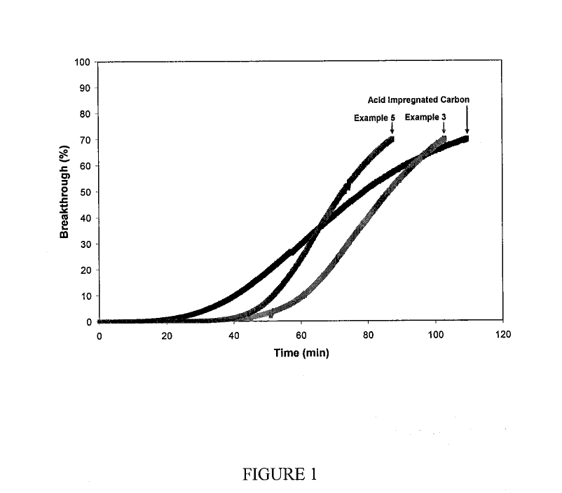

The lower structure and water absorption of precipitated silica A, yielded an insufficient holding capacity for the 30% H₂SO₄ impregnation and the accompanying water, when equilibrated at a relative humidity of 50%. This resulted in wetting of the media bed, where acid laden moisture was emitted out of the effluent side, resulting in corrosion of the support screen. Both of the 30% H₂SO₄ impregnated higher structure precipitated silicas, remained dry at 50% relative humidity, and showed noticeably higher removal efficiencies than the impregnated carbon, which resulted in their longer times and higher capacities at 10% breakthrough. These higher removal efficiencies also resulted in sharper breakthroughs, since a higher percentage of the total capacity was being consumed prior to initial breakthrough. The results are presented in FIG. 1 and in Table 3.

ii. 40% Loading

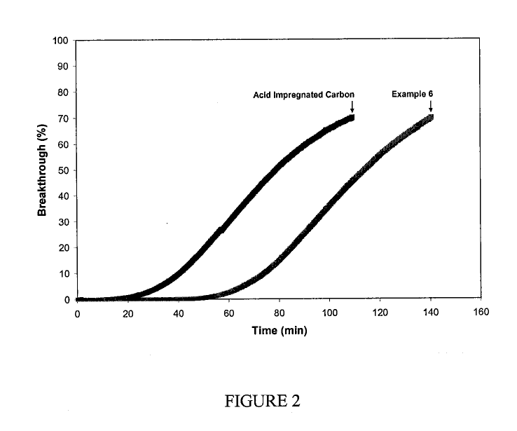

The lower water absorptions of precipitated silicas A and B yielded insufficient holding capacities for the 40% H₂SO₄ impregnation and the accompanying water, when equilibrated at a relative humidity of 50%. This resulted in wetting of both media beds, where acid laden moisture was emitted out of the effluent side, resulting in corrosion of the support screen. The 40% H₂SO₄ impregnated high structure precipitated silica, remained dry at 50% relative humidity, and showed noticeably higher removal efficiencies than the impregnated carbon, which resulted in its longer time and higher capacity at 10% breakthrough. This higher removal efficiency resulted in similar slope for the breakthrough curve even though the capacity at 70% breakthrough was over 40% higher. A similar phenomenon happened when a coconut shell activated carbon was wet impregnated with 40% H₂SO₄. Salt formation was observed on the exterior of the carbon granules, which seemed to wet resulting in corrosion of the support screen. The results are presented in FIG. 2 and in Table 3.

TABLE 3
Ammonia Breakthrough Measurements

| | |
|---|---|
| 10% | 70% |
| Breakthrough | Breakthrough |

| | Time | Capacity | Time | Capacity |
|---|---|---|---|---|
| Inventive Example | (min) | (mg/cm³) | (min) | (mg/cm³) |
| Acid-Impregnated | 40.5 | 15.3 | 109.5 | 30.1 |
| Carbon (Control) | | | | |
| 3 | 60.8 | 23.1 | 102.9 | 32.5 |
| 5 | 51.7 | 19.7 | 87.4 | 27.6 |
| 6 | 74.3 | 28.3 | 140.8 | 43.0 |

The results show that the carbon control performed equally if not better than the 30% acid loaded silica materials. At 40% acid loading, however, the silica materials were better at ammonia removal.

Acid Impregnated Silicas with Various Binder Systems

The binder treated materials (both comparative and inventive) were then measured for hardness and ammonia breakthrough.

Typical hardness numbers for these wet granulated silicas with no binder and with or without acid impregnation ranged from about 20-40. The addition of Attagel clay as a binder drastically improved the hardness of the granules when no acid was present. However, upon the addition of the active impregnant (H₂SO₄) the binder became less effective, resulting in decreased hardness numbers (as the table below shows).

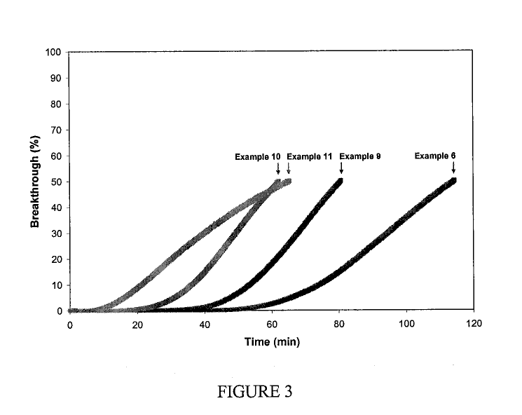

As the loading of Catapal pseudo boehmite increased so did the ball-pan hardness numbers. However, this increase in hardness was also accompanied by a decrease in ammonia removal performance, as is indicated in FIG. 3 and Table 5. Although blinding off of the porosity could contribute, the main reason for this loss in performance was a reaction between the Catapal and the H₂SO₄, which was made apparent from looking at the 5% pH of these medias. As can be seen in Table 4, the 5% pH increased as the Catapal loading was increased. It was unclear whether the effectiveness of this binder was due to the increased loading or a result of the acid neutralization.

While the addition of the polysilicic acid binder system dramatically increased the hardness of the media, it had minimal affect on the ammonia removal performance. As such, this system provided excellent characteristics for use within various applications requiring such versatile filter media.

TABLE 4
Ammonia Breakthrough Measurements for Acid-Impregnated
Silica Granules

| | |
|---|---|
| 10% | 50% |
| Breakthrough | Breakthrough |

| | Time | Capacity | Time | Capacity |
|---|---|---|---|---|
| Example | (min) | (mg/cm³) | (min) | (mg/cm³) |
| Inventive 6 | 74.3 | 28.3 | 114.4 | 39.2 |
| Comparative 3 | 53.4 | 20.4 | 80.7 | 27.8 |
| Comparative 4 | 36.1 | 13.7 | 62.1 | 20.7 |
| Comparative 5 | 21.2 | 7.9 | 65.1 | 19.4 |

TABLE 5
Ammonia Breakthrough Measurements for Acid-Impregnated
Filter Media

| | 10% Breakthrough | | 70% Breakthrough | |
|---|---|---|---|---|
| | Time | Capacity | Time | Capacity |
| Inventive Example | (min) | (mg/cm³) | (min) | (mg/cm³) |
| Acid Impregnated Carbon | 40.5 | 15.3 | 109.5 | 30.1 |
| 6 | 74.3 | 28.3 | 140.8 | 43.0 |
| 7 | 78.4 | 30.0 | 135.7 | 42.4 |

### DETAILED DESCRIPTIONS OF THE DRAWINGS

FIG. 1 shows the graphical representation of the breakthrough curves of Table 3 for an acid-impregnated carbon and the 30% H₂SO₄ impregnated media produced in Inventive Examples 3 and 5. The test conditions were as follows: Flow Rate—19608 SCCM, Media Velocity—25 cm/sec, Bed Dimensions—0.135 cm×4.08 cm, Relative Humidity—50±3%, Ammonia Concentration—50 ppm.

FIG. 2, likewise, shows the graphical representation of the breakthrough curves of Table 3 for an acid-impregnated carbon and the 40% H₂SO₄ impregnated medias produced in Inventive Example 6. The same test conditions as above were followed.

FIG. 3 shows the graphical representation of the breakthrough curves of Table 4 for comparative materials with binder systems produced in Comparative Examples 3, 4, and 5 with the same test conditions as above.

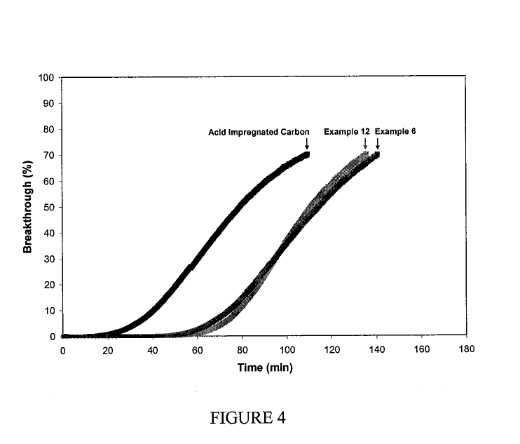

FIG. 4 shows the graphical representation of the breakthrough curves of Table 5 for a leading acid-impregnated carbon and the H₂SO₄ impregnated medias produced in Inventive Examples 6 and 7 (without and with the polysilicic acid binder system). The test conditions were the same as followed above.

The results show that higher acid-impregnation loading for silica materials provides improved ammonia breakthrough, and a binder system provides similar breakthrough results with increased hardness for certain applications requiring such specific properties.

While the invention was described and disclosed in connection with certain preferred embodiments and practices, it is in no way intended to limit the invention to those specific embodiments, rather it is intended to cover equivalent structures structural equivalents and all alternative embodiments and modifications as may be defined by the scope of the appended claims and equivalents thereto.

What we claim is:

1. A filter medium comprising acid-impregnated precipitated silica materials, wherein said materials exhibit a BET surface area of between about 20 and 700 m²/g and a water absorption of between about 50 and 500 cm³ of water per 100 g of silica; and wherein the acid impregnant is selected from the group consisting of at least one mineral acid and at least one weak organic acid, and any mixtures thereof, and is present in an amount of from 1 to 50% by weight of the total amount of the final impregnated media. The porosity of the silica materials may range from microporous to macroporous and the materials themselves are preferably granulated, with the acid predominantly present on the interior surfaces of the subject silica particles.

2. The filter medium of claim 1 wherein said BET surface area is between about 200 and about 700 m²/g, and wherein said water absorption is between about 200 and about 500 cm³/100 g.

3. The filter medium of claim 1 wherein said acid impregnant is at least one mineral acid.

4. The filter medium of claim 3 wherein said at least one mineral acid is selected from the group consisting of phosphoric acid, sulfuric acid, hydrochloric acid, nitric acid, sulfamic acid, and any mixtures thereof.

5. The filter medium of claim 1 wherein said acid impregnant is at least one weak organic acid.

6. The filter medium of claim 5 wherein said at least one weak organic acid is selected from the group consisting of citric acid, oxalic acid, and any mixtures thereof.

7. The filter medium of claim 1 wherein said acid-impregnated precipitated silica materials further exhibit the following properties:
i) linseed oil absorptions of 50 to 500 cm³/100 g;
ii) pore diameters ranging from 1 to 1000 Å;
iii) a pore volume of between about 0.25 to about 0.5 cc/g; and
iv) average pore diameters ranging from 1 to 500 Å.

8. A filter system comprising the filter medium as defined in claim 1.

9. A filter system comprising the filter medium as defined in claim 2.

10. A filter system comprising the filter medium as defined in claim 3.

11. A filter system comprising the filter medium as defined in claim 4.

12. A filter system comprising the filter medium as defined in claim 5.

13. A filter system comprising the filter medium as defined in claim 6.

14. A filter system comprising the filter medium as defined in claim 7.

15. An acid-impregnated precipitated silica filter medium that exhibits a 10% breakthrough measurement for an ammonia gas/air composition a) when present as a filter bed of 0.135 cm in height within a flask of a diameter of 4.1 cm, b) when exposed to a constant ammonia gas concentration of 50 ppm at a media velocity of 25 cm/sec at ambient temperature and pressure, and c) when exposed simultaneously to a relative humidity from 10% to 60%; and wherein said filter medium, after 10% breakthrough is reached, does not exhibit zany ammonia gas elution in excess of said breakthrough concentration.

16. A filter system comprising the filter medium of claim 15.
